(19) United States
(12) Patent Application Publication
(10) Pub. No.: US 2024/0078537 A1
(43) Pub. Date: Mar. 7, 2024

(54) METHODS AND SYSTEMS FOR USAGE-CONDITIONED ACCESS CONTROL BASED ON A BLOCKCHAIN WALLET

(71) Applicant: Shopify Inc., Ottawa (CA)

(72) Inventor: Nicole SANDFORD, Kitchener (CA)

(73) Assignee: Shopify Inc., Ottawa, ON (CA)

(21) Appl. No.: 17/903,109

(22) Filed: Sep. 6, 2022

(51) Int. Cl. G06Q 20/36; G06Q 20/38

(52) U.S. Cl. CPC G06Q 20/3674; G06Q 20/38215

(57) ABSTRACT

A method and system for identifying and notifying prospective users. The system may be an online multi-user platform that determines a set of users based on user data for the multi-user platform. The system may have wallet data associated with at least some of the users in the set of users. The system may then identify at least one token attribute correlated to the set of users and identify a plurality of blockchain wallet addresses associated with wallets each holding one or more tokens matching the token attribute. It may then generate and send a communication to addresses linked to the wallet addresses associated with the wallets holding the matching tokens.

### TECHNICAL FIELD

The present disclosure relates to computer-implemented access control systems and methods and, in particular, systems and methods for controlling access to resources using a token-based condition.

### BACKGROUND

Many online systems that have a set of known users generate automated communications directed to those users. In some cases, it is desirable to generate and send automated communications to prospective users; however, the system does not have contact data for users not yet on the system to enable it to direct those communications to the prospective users. Accordingly, platforms that send communications to prospective users typically need to purchase clustered or segmented data including contact information. That data is typically purchased from third party providers and enables the system to direct communications to prospective users. Examples of such systems may include online gaming platforms, e-commerce systems, online social media networks, and any other such platforms that have a set of users.

### BRIEF DESCRIPTION OF THE DRAWINGS

Embodiments will be described, by way of example only, with reference to the accompanying figures wherein:

FIG. 1 is a simplified example system;

FIG. 2 is a high-level schematic diagram of a computing device;

FIG. 3 shows a simplified organization of software components stored in a memory of the computing device of FIG. 2;

FIG. 4 graphically illustrates an example segment of a blockchain recording non-fungible tokens;

FIG. 5 shows, in flowchart form, one example method of identifying and communicating with prospective users of a multi-user online platform;

FIG. 6 shows, in flowchart form, another example method of identifying and communicating with prospective users of a multi-user online platform;

FIG. 7 is a block diagram of an e-commerce platform, in accordance with an example embodiment; and

FIG. 8 is an example of a home page of an administrator, in accordance with an example embodiment.

Like reference numerals are used in the drawings to denote like elements and features.

### DETAILED DESCRIPTION OF EMBODIMENTS

In some examples, the present application discloses methods and systems for identifying and communicating with prospective users. The methods and systems may identify a group or cluster of known users and, using wallet data associated with at least some of the users, may identify a blockchain token attribute associated with the group or cluster of known users. On this basis, blockchain data from a blockchain network may be searched to find blockchain wallets having the blockchain token attribute. Those identified blockchain wallets may be associated with prospective members of the group or cluster and may therefore be prospective users. The method and system may then generate and send a communication to addresses associated with the identified blockchain wallets to reach the prospective users.

In one aspect, the present application provides a computer-implemented method that may include receiving an indication of a set of users, the set of users identified based on user data; identifying at least one token attribute correlated to the set of users; identifying a plurality of blockchain wallet addresses associated with wallets each holding one or more tokens matching the token attribute; and generating and sending a communication to addresses linked to the wallet addresses associated with the wallets holding the matching tokens.

In some implementations, receiving the indication of the set of users includes identifying, in a database of user data relating to an online platform, the set of users based on a user characteristic. In some cases, the user characteristic is based on user history on the online platform.

In some implementations, receiving includes receiving blockchain wallet addresses for at least some users in the set of users, and wherein identifying the at least one token attribute includes comparing wallet holdings or wallet history for the blockchain wallet addresses to identify the at least one token attribute. In some cases, comparing wallet holding or wallet history includes obtaining wallet data for the blockchain wallet addresses from a blockchain node, and identifying the at least one token attribute through finding a common feature of the blockchain wallet addresses in the wallet data. In some cases, identifying the at least one token attribute includes determining that more than a threshold percentage of the blockchain wallet addresses has the at least one token attribute.

In some implementations, identifying the at least one token attribute includes comparing wallet data associated with users in the set of users with wallet data associated with users not in the set of users and determining that the at least one token attribute is correlated with membership in the set of users.

In some implementations, the at least one token attribute includes holding a non-fungible token from a specific token collection.

In some implementations, identifying the plurality of blockchain wallet addresses includes searching blockchain data regarding a blockchain based on the at least one token attribute to find the plurality of blockchain wallet addresses having the at least one token attribute. In some cases, searching includes filtering the blockchain data to exclude at least some wallet addresses. Filtering may include filtering to exclude wallet addresses associated with the set of users and/or filtering to exclude a wallet address based on a measure of transfer activity in the wallet address.

In another aspect, the present application discloses a computing system including one or more processing units, one or more data storage units, and memory storing processor-executable instructions that, when executed by the one or more processing units, are to cause the processing units to carry out the operations of one or more of the methods described herein.

In yet another aspect, a non-transitory, computer readable storage medium is disclosed. The medium may store processor-executable instructions that, when executed, cause one or more processors to carry out the operations of one or more of the methods or processes described herein.

Other example embodiments of the present disclosure will be apparent to those of ordinary skill in the art from a review of the following detailed descriptions in conjunction with the drawings.

In the present application, the term “and/or” is intended to cover all possible combinations and sub-combinations of the listed elements, including any one of the listed elements alone, any sub-combination, or all of the elements, and without necessarily excluding additional elements.

In the present application, the phrase “at least one of . . . and . . . ” is intended to cover any one or more of the listed elements, including any one of the listed elements alone, any sub-combination, or all of the elements, without necessarily excluding any additional elements, and without necessarily requiring all of the elements.

In the present application, the terms “e-commerce platform” or “e-commerce system” refers broadly to a computerized system (or service, platform, etc.) that facilitates commercial transactions, namely buying and selling activities over a computer network (e.g., Internet). An e-commerce platform may, for example, be a free-standing online store, a social network, a social media platform, and the like. Customers can initiate transactions, and associated payment requests, via an e-commerce platform, and the e-commerce platform may be equipped with transaction/payment processing components or delegate such processing activities to one or more third-party services. An e-commerce platform may be extendible/extensible by connecting one or more additional sales channels representing platforms where products can be sold. The e-commerce platform may serve one merchant in some implementations. The e-commerce platform may be a multi-merchant platform in other cases, where each merchant is able to use some or all of the available services to configure an online storefront and provide commerce services to customers of the online storefront. A multi-merchant e-commerce platform may operate across a range of geographic regions, and may operate in multiple countries, currencies, and time zones.

Some of the examples below refer to a “product record”. A product record in this context may refer to data regarding a specific product item, or a specific version of that product item. The data may include details of the product item, technical specifications, narrative description, image(s) of the product item, customer reviews, pricing information, inventory information, shipping information, or any other product data of a similar nature. In some cases a product record may be a web page. In some cases, the product record may be an XML record. The product record may be embodied in any other suitable mark-up language or other coding language.

The growth of blockchain networks has led to the development of non-fungible tokens (NFT). Each NFT is a unique combination of characteristics/attributes and/or media. Each NFT also has a unique token ID.

In many implementations, a smart contract may be created for the purpose of minting and/or tracking NFTs. As an example, the Ethereum blockchain network has an associated standard, ERC-721, providing a reference implementation of a smart contract for tracking and managing NFTs. Various other standards, such as ERC-1155 for fungible and non-fungible tokens and/or ERC-20 for fungible tokens, may apply. In some cases, the NFTs generated by a smart contract may form a collection, in that the NFTs generated by that smart contract have some limited universe of possible attributes or characteristics. In some cases, the NFTs in a collection are computer-generated art in which various layers of digital art are made available for pseudo-randomized selection to generate each unique digital media. The layers may correspond to particular characteristics, such as various eyes, mouths, hats, accessories, etc., used to generate a unique digital image of a character. In some other cases, the NFTs in a collection may be images or videos that relate to a particular type of activity, sport, or other interest, such as images or videos of particular football players, video clips from baseball plays, photographs of a specific celebrity or group of celebrities, etc. Example NFT collections include, for example, the “Bored Ape” collection, the “NBA™ TopShot” collection, or the “Invisible Friends” collection.

A smart contract is executable computer code recorded on the blockchain that, when properly “called” in a subsequent blockchain transaction, executes so as to carry out its defined operations. In the case of an NFT smart contract, a minting operation may cause the smart contract to produce a new unique NFT that corresponds to a particular one unique NFT. That unique NFT may be digital art, an image, a video, or a combination thereof in some examples. Each NFT may have associated attributes or characteristics. Example attributes include the elements pseudo-randomly selected for generation of the digital image, such as specific eyes, mouth, accessories, etc., for an image of a character. Another set of example attributes may be the context or characteristics of a particular image or video, such as the identity of the person/player featured, the team or teams involved, the date, the score, the type of play, or other such features.

Once NFTs are minted, they may be made available through an online marketplace in some cases. Various wallets, i.e. network-connected computing devices with blockchain wallet software operating thereon, may initiate blockchain transactions to obtain and/or transfer NFTs. Ownership of an NFT by a wallet is recorded on-chain and is verifiable by third parties. In some cases, a wallet may own a plurality of NFTs. The ownership of those NFTs may be verifiable by third parties based on a query to the blockchain network, i.e. to a blockchain node, providing data from the wallet, such as a public key associated with the wallet. In some cases the query may identify the NFTs by way of unique identifiers, or by way of an identifier for the NFT collection to which they belong. The blockchain node may respond by providing verification that the public key provided is associated with the NFT as reflected in the data recorded on the blockchain. The NFT smart contract may provide functions for verifying NFT ownership data.

While many NFTs have been generated to represent ownership interest in some auto-generated digital media, in other cases NFTs may be used as a “proof-of-purchase” or a receipt or record of ownership or investment. In this context, NFTs may indicate a history of purchases or certain product items and, in some cases, record current ownership of those product items. An NFT may be as simple as a record of purchase (receipt) for various common items from a grocery store. In some cases, the NFT may be a record of ownership of a non-perishable real-world item, such as real estate, a financial instrument, an automobile, etc.

In yet other examples, NFTs may be used as a “ticket” for access or as a “proof-of-attendance”. For instance, a concert ticket may be minted as an NFT, which when validated at a venue (e.g. using a QR code scanner or the like to obtain a wallet identifier and an NFT identifier and then validate ownership via a blockchain query) grants the holder of the user device access to the concert. As another example, an NFT may record the fact of attendance at an event, such as a training course or a social event. NFTs may signal membership in a club, attendance at a restaurant, participation or level or progress in an online game, or any other such events.

Access control systems may rely on rule sets that specify conditions for granting or denying access to a resource. An administrator of such a system must usually determine the applicable condition or combination of conditions in advance and embody them in suitable access control rules. The system then, in response to a request for access from a requesting device, retrieves the access control rules and assesses whether the requesting device and/or its present context meets the condition or combination of conditions specified in one of the access control rules. Access to the resource is then granted or denied based on that assessment. In this manner, the system gates access to the resource based on the condition or combination of conditions.

In some situations, access control rules may be set that include conditions relating to token holdings. That is, an access control rule may limit access to the online resource to user devices that have a blockchain wallet associated with ownership of one or more tokens or types of tokens. The tokens may be fungible or non-fungible. The condition may indicate that the token or tokens be from one or more specific collections or categories of tokens. The condition may indicate that the token from a certain collection is to have one or more particular attributes or features. There are a range of token-based access conditions that may be set.

In some examples, the restricted online resource may be a webpage, server login, computer game, livestream, or other such online resource to which access may be controlled. In an illustrative example, the online resource may be an e-commerce product or service. That is, access to one or more products or services available via an e-commerce system or platform may be controlled based on ownership of one or more tokens (e.g. NFTs) having certain characteristics or attributes. In some cases, the restricted access is to a discount, coupon, or points program. In some cases, the restricted access is to a version of a webpage or other online resource associated with the product or service that includes a discount or incentive not otherwise available for that product or service. The online resource may be accessed by a computing device via a webpage or mobile app interface, wherein a remote server, e.g. an e-commerce platform, determines that access by the computing device is permitted based on verification that one or more NFTs meeting the access conditions are associated with the computing device.

To prove ownership of one or more tokens, a user connecting to a system through a user device causes the user device to provide wallet information to the system. This may employ certain WalletConnect protocols, in some cases. The system may challenge the user device using a message, and the user device may provide the system with a wallet address and a digital signature over the message that evidences possession by the user device of the private key that corresponds to a public key associated with the wallet address. The system may cryptographically verify that the digital signature corresponds to the wallet address. The system may then obtain data from a blockchain network regarding the wallet address, for example, ownership data detailing the fungible or non-fungible tokens held by that wallet address. Alternatively, the system may obtain blockchain data detailing the wallet addresses that hold a particular NFT or set of NFTs and may determine whether the wallet address provided by the user device matches one of those obtained in the blockchain data. In this manner, the system is able to determine that the user device is associated with the wallet address, validate using the blockchain which tokens the wallet address holds, and determine whether those tokens satisfy the access condition.

As noted above, in many situations, a multi-user online system or platform may generate and send a communication to a set of prospective users. In order to identify prospective users, the system or platform may identify one or more characteristics of its existing user base and attempt to identify prospective users having the same one or more characteristics. To do so, an administrator of the system or platform may need to purchase user data from a third party. The user data may have been collected by other systems or platforms based on their own users' activities and then made available for purchase by others. That data may include user contact information that may be used by the system or platform to send a communication to prospective users it identifies in the data. Obviously, such a technique relies upon a third party system to collect user data and make it available for purchase, and relies upon the integrity and reliability of that third party system.

A multi-user platform may have a great deal of information regarding its existing user base. For example, an e-commerce system may have information regarding the identity of the user, their location, and in some cases their age and gender. It may also have data regarding the user's history on the system or platform, such as a transaction history, a browsing history, a history of “likes” or other reactions to content, and other system-specific history. From all this data on the existing user base, the multi-user platform is able to perform rich and detailed segmentation and analysis of its own user base to identify characteristics of users. In some cases the segmentation may identify one or more characteristics of a user that are associated with use or affinity with a specific feature, product, transaction, option, or other element of the system.

As noted above, some multi-user platforms may obtain blockchain wallet information from users. In some cases, this may be collected in connection with access control operations, but it may be obtained for other purposes. The blockchain wallet information for users of the multi-user platforms may be obtained through WalletConnect protocols or similar operations in which a user device associated with a user account provides wallet address data and authentication data from which the platform can verify ownership of the wallet address data. The multi-user platform may obtain wallet data for a wallet address associated with a user account from a blockchain network or from a blockchain indexing service that provides blockchain data from the blockchain network. The wallet data may detail the contents of the wallet having that wallet address, such as details regarding the fungible and non-fungible tokens held by that wallet address. In some cases, it may include not just current holdings but also a wallet history, such as the history of transactions involving that wallet address. This may include details of tokens received or transferred and dates and times of transactions.

A multi-user platform that has blockchain wallet information for at least some of its user base may incorporate the blockchain wallet information into its segmentation and analysis of its users, thereby identifying one or more token attributes correlated with a set of users. The token attributes may be correlated in that at least a threshold percentage of the users in a defined set have a wallet that meets the one or more token attributes. Correlation may be determined using a range of algorithms for detecting an association between membership in a class and a particular user characteristic, wherein the user characteristic in this case is having a wallet with one or more token attributes.

Token attributes may refer to a token holding or a token history. Token attributes may refer to holding a certain type or class of token, such a non-fungible token, or a non-fungible token from a particular collection, or a minimum quantity of certain fungible or non-fungible tokens, as examples. Token attributes may refer to one or more features or qualities of a token, such as a Bored Ape having a particular feature, like a hat or beard or other accessory.

Advantageously, a multi-user platform that is able to identify one or more token attributes correlated to a set of its users on the basis of blockchain wallet information obtained from its user base, is then able to identify other wallets on the blockchain that have the same one or more token attributes. This provides the multi-user platform with an independent mechanism for identifying prospective users that does not necessarily rely on purchasing data collected by third parties. Moreover, the platform then bases its prospective user identification on immutable blockchain data rather than trusting in a third party system to provide accurate unaltered user data.

Accordingly, in one aspect, the present application provides for system and methods of finding and contacting prospective users that include identifying at least one token attribute correlated to a set of users of a multi-user platform, identifying blockchain wallet addresses associated with wallets having the at least one token attribute, and generating and sending a communication to addresses linked to the blockchain wallet addresses associated with the wallets having the at least one token attribute.

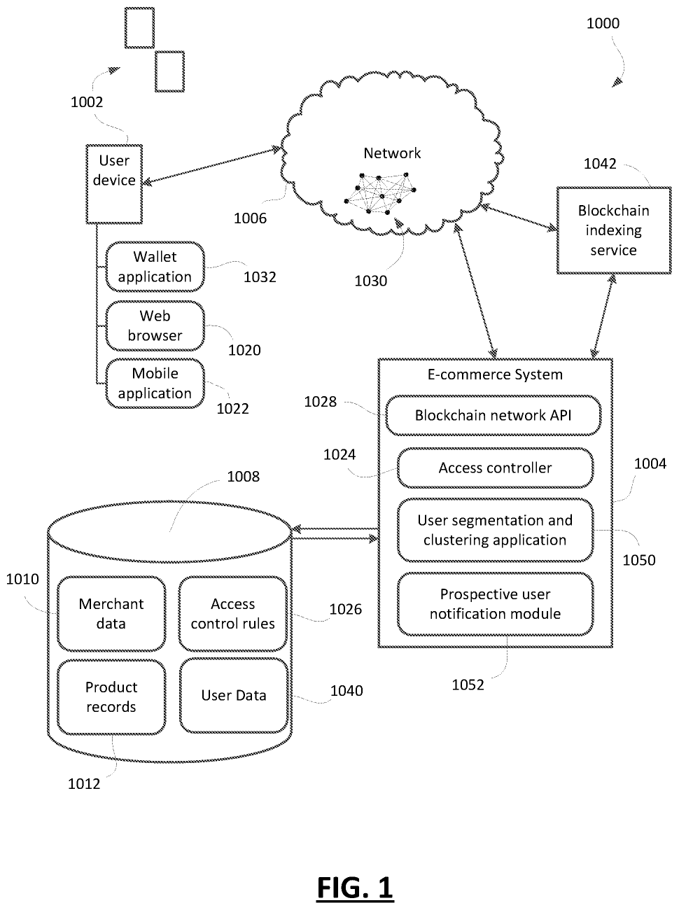

Reference will now be made to FIG. 1, which diagrammatically illustrates a simplified example system 1000 in accordance with an aspect of the present application. In this example, the system 1000 includes a network-connected multi-user platform, which in this example is an e-commerce system 1004, and a plurality of user devices 1002. The user devices 1002 and e-commerce system 1004 may communicate over a network 1006. The network 1006 may include interconnected wired and/or wireless networks, including the Internet. The user devices 1002 may include a range of computing devices, such as laptops, desktops, tablets, smartphones, and the like.

The e-commerce system 1004 may be implemented using one or more servers. The e-commerce system 1004 may include data storage 1008, which may include one or more databases or other data structures within or accessible to the servers. The data storage 1008 may include merchant data 1010 regarding merchant accounts with the e-commerce system 1004, including merchant identifiers and settings and parameters for respective merchants. The data storage 1008 may further include product records 1012. In some cases, each merchant account has a set of associated product records 1012 reflecting the products or services offered via that merchant account. The product records 1012 may include details regarding one or more products, images, pricing, shipping information, technical parameters, textual description, reviews, or other data regarding the product. Product records 1012 may be grouped into classes and/or subclasses.

The data storage 1008 may further include user data 1040. The user data 1040 may include data regarding non-merchant users of the multi-user e-commerce system 1004. The user data 1040 may include a user account identifier, corresponding user profile information, and user contact information. In some cases, it may include user attributes, such as age, location, credit score, etc. In some cases, it may include stored payment credentials, such as credit card information. In some implementations, the user data 1040 includes user history regarding the e-commerce system 1004. The user history may include a history of transactions (e.g. purchases, returns, redemptions, etc.), a browsing history, and/or a record of “likes”, “wishes”, or other active indications of interest received from the user device 1002 based on user selections.

The user devices 1002 may include a web browser 1020 and/or a mobile application 1022 through which the user device 1002 is able to connect with the e-commerce system 1004 in order to browse a merchant's online store interface so as to view available products or services. The web pages or other resources served to the user devices 1002 via the web browser 1020 or mobile application 1022 may be generated or obtained from the stored product records 1012. As a user device 1002 searches or browses products from a particular merchant, the e-commerce system 1004 may retrieve the corresponding product records 1012 for causing display of the product data on the user device 1002. In some implementations, the merchant data 1010 may include settings or parameters that configure the UI and presentation served to the user devices 1002, thereby providing users with a merchant-specific storefront within which to browse and purchase items.

The e-commerce system 1004 includes an access controller 1024. The access controller 1024 may be implemented by way of suitable computer executable code for regulating access to some or all of the product records 1012 and other data within the e-commerce system 1004. In one example, the access controller 1024 may limit access to some or all of the features or options available by way of user authentication. That is, user's, such as customers or merchants, accessing the e-commerce system using a remote device must provide valid user credentials to be authenticated. Once authenticated, the user is granted the level of access corresponding to their user type or class. A merchant user may gain access to edit its product records 1012, store design, and some of its merchant data 1010. In some cases, a customer user need not provide any user credentials and is permitted to browse merchant stores or to make purchases in a “guest” mode. If credentials are provided, the user may be “logged in” to a user account that enables access to additional features or saved preferences, including purchase history, loyalty points, saved purchase credentials (e.g. credit card details), or other user-specific features.

In this example, the network 1006 further includes a blockchain network 1030. The blockchain network 1030 may operate in accordance with a blockchain protocol, such as Bitcoin or Ethereum, as examples. The user device 1002 may include a wallet application 1032, which is a blockchain application on the user device 1002 that may store blockchain-related data. In some cases, the wallet application 1032 may securely store public and private key pairs. The public keys may be shared and made publicly available for the purpose of receiving blockchain-based data transfers of fungible or non-fungible tokens. The private keys may be stored securely and confidentially and may be used by the wallet application 1032 in certain signature operations for providing digital signatures that prove ownership of corresponding public keys, among other things. The public keys may represent or be mathematically linked to corresponding wallet addresses. The wallet address may be referenced in blockchain transactions as a sender or recipient of digital assets. A given wallet address may be recorded as the “owner” or holder of one or more digital assets, as reflected by the blockchain. The wallet application 1032 may be referred to as a simplified payment verification (SPV) client in some implementations.

The wallet application 1032, in this example, may include data with regard to tokens, such as one or more NFTs, associated with the wallet address. The data may include, in some cases, an token identifier, a public key associated with the wallet (e.g. a wallet identifier or address), a transaction identifier associated with ownership of the NFT, an NFT collection identifier, a smart contract identifier, or other such data regarding the token(s). In some cases, the data may include additional data regarding an NFT itself, such as associated media (e.g. image or video), attributes, or a textual description.

In some implementations, the wallet application 1032 may be configured to provide data to the e-commerce system 1004, such as wallet address information and/or token data. For example, the wallet application 1032 may use an open-source WalletConnect protocol or other such protocol to connect and interact with decentralized applications (dApps). In some cases, the connect protocol may be used to connect the wallet application 1032 to the mobile application 1022. In some cases the connect protocol may be used to connect the wallet application 1032 to the web browser 1020. In short, the wallet application 1032 is configured such that it is able to securely provide wallet address and/or token data to the e-commerce system regarding tokens purportedly owned by the user device 1002, and/or to authenticate the user device's 1002 ownership of certain public keys associated with particular wallet addresses.

The access controller 1024 may be configured to control access to one or more of the product records 1012 based upon access control rules 1026. Each access control rule 1026 may specify one or more product records 1012, or a class of product records 1012, to which it applies. Each access control rule 1026 may be associated with a specified one of the merchant accounts. Each access control rule 1026 may further include a condition for obtaining access to the associated one or more product records 1012 or class of product records 1012. The condition, in these examples, may include ownership of one or more tokens meeting token criteria, such as being from a specified NFT collection or having a specified set of attributes.

The e-commerce system 1004 and, in particular, the access controller 1024, may be configured to verify, in response to a request from the user device 1002, that the associated wallet address provided by the user device 1002 meets an access condition within an access control rule 1026. The access controller 1024 may be triggered to verify an access condition is satisfied if a restricted access product record is requested during a first phase of a user session, such as during product browsing or product search. The access controller 1024 may alternatively or additionally be triggered to verify the same access condition is satisfied if that restricted access product record is referenced when a request for checkout is received and/or a payment operation is initiated.

The access controller 1024 may be configured to obtain a wallet address and a digital signature from one of the user devices 1002, and to validate that the digital signature confirms ownership of a public key corresponding to the wallet address. It may further be configured to store the wallet address, digital signature, and/or message signed by the digital signature in association with the user session. Wallet information obtained from a user device 1002 may be stored as user data 1040 in association with the corresponding user account. A user record in the user data 1040 may therefore include authenticated blockchain wallet address information associated with that user profile. The blockchain information stored in the user data 1040 may also include information regarding the holdings or history recorded on the blockchain with regard to that wallet address, indicating tokens held, token attributes, blockchain transaction history, etc.

The e-commerce system 1004 may further include a blockchain network API 1028 configured to obtain blockchain data from the blockchain network 1030, such as ownership data regarding a particular wallet address. The blockchain network API 1028 may be configured to query a blockchain node within the blockchain network. In some implementations, the e-commerce system 1004 itself operates a blockchain node. The blockchain network API 1028 may receive a request for token information from the access controller 1024, which may provide one or more wallet addresses. The blockchain network API 1028 may then query the blockchain network 1030 for token ownership information with respect to the wallet addresses and may receive data specifying the tokens owned by each of the respective wallet addresses according to the blockchain. The blockchain network API 1028 may then pass that token ownership information to the access controller 1024 to enable it to determine whether one or more of the wallet addresses satisfy the access condition(s) of a particular access control rule 1026.

In some cases, the system 1000 may include a blockchain indexing service 1042 configured to monitor the blockchain network 1030 and to track and index data from that blockchain. The blockchain indexing service 1042 may be configured to respond to queries, such as to provide the current and/or history of token ownership for a particular wallet address, for example. The blockchain network API 1028 may be configured to send query requests to the blockchain indexing service 1042. In some cases, the blockchain indexing service 1042 may be incorporated within the e-commerce system 1004.

In this example, the e-commerce system 1004 further includes a user segmentation and clustering application (USCA) 1050. The USCA 1050 may be configured to segment and cluster users having accounts with the e-commerce system based on the user data 1040. The segmentation and clustering may be carried out based on one or more criteria input by an administrator of the e-commerce system 1004 as parameters on which the segmentation and clustering is based. For instance, the USCA 1050 may be configured to identify a set of users that have a demonstrated affinity for running shoes and to output one or more dominant characteristics correlated to that group of users. The USCA 1050 may be configured to identify the set based on at least one transaction involving running shoes in a time period, e.g. purchase in the last six months, or based on a minimum threshold browsing time or number of pages browsed in association with running shoe products. Other measures or indicia may be used to identify the set of users.

Once the set is identified, the USCA 1050 may analyze user data for the users in the set to identify one or more user attributes or characteristics held by all or a large portion of the users in the set. In some cases, the analysis includes analysis of user data for users not in the set to measure the strength of correlation between the characteristic and membership in the set. Various techniques may be used for measuring such correlation.

In this example, one of the characteristics or attributes that the USCA 1050 analyzes to try to identify correlation with membership in the set of users is token attributes. That is, the USCA 1050 may determine, based on blockchain wallet data for the users in the user data 1040, whether membership in the set of users is correlated to blockchain wallet holdings, such as ownership of a particular type or class of token, ownership of a type of fungible token, holding more than a minimum quantity of fungible or non-fungible tokens, holding a token having one or more particular attributes. The USCA 1050 may determine whether membership in the set of users is correlated to blockchain wallet history, such as a quantity of blockchain transactions over a time window, past ownership of a certain type of token, past transfer of a token(s) associated with particular merchant(s), etc. In some cases, the USCA 1050 may determine whether membership in the set of users is correlated to use of one or more tokens in satisfying an access control condition on the e-commerce system 1004. These wallet holdings, wallet history, or token usage features may be referred to herein as “token attributes”, such that the USCA 1050 is determining whether there are one or more token attributes correlated to the set of users.

In some implementations, the detecting of correlation between a token attribute and the set of users may take into account that the e-commerce system 1004 may not have wallet information for all of the users. Only some of the users in the set of users may have previously provided the e-commerce system 1004 with wallet information, such that the user data 1040 only has blockchain wallet data for some of the users that are members of the set. In some cases, the USCA 1050 may detect correlation between token attributes and membership in the set of users by using only user data for those users for which it has wallet information. For instance, if the e-commerce system 1004 has wallet information for 20% of users in the user data 1040, then only those users are factored into the analysis of whether there are one or more token attributes associated with membership in the set of users.

The e-commerce system 1004 may further include a prospective user notification module 1052. Once the USCA 1050 identifies one or more token attributes associated with membership in the set of users, it may provide those one or more token attributes to the prospective user notification module 1052. The prospective user notification module 1052 may then use that data to identify one or more wallet addresses on the blockchain that share the identified one or more token attributes. In some cases the prospective user notification module 1052 may, for example via the blockchain API 1028, query the blockchain to identify a list of wallet addresses that meet that criteria. The query may be sent to the blockchain indexing service 1042 in some cases. In some cases, the prospective user notification module 1052 may be configured to apply additional query criteria besides the one or more token attributes.

The list of wallet addresses that have the one or more token attributes may include the wallet addresses associated with existing users of the e-commerce system, such as at least some of the users in the set of users. Accordingly, the prospective user notification module 1052 may filter the query results to exclude wallet addresses associated with any member of the set of users. In some cases, the filtering may further exclude any wallet addresses that are existing users in the user data 1040 but are not members of the set of users. The filtered set of wallet addresses provides a set of addresses associated with prospective users.

In order to generate and send a notification, the prospective user notification module 1052 may utilize the filtered wallet addresses. In one implementation, the blockchain network protocol associated with the blockchain network 1030 enables wallet-to-wallet messaging. In such circumstances, the prospective user notification module 1052, itself or through the blockchain network API, may generate and send a notification or message to the wallet addresses using a wallet address associated with the e-commerce system 1004. In another implementation, the prospective user notification module 1052 may send the notification by generating and transferring a token to the filtered wallet addresses, where the token constitutes the notification. The token may be an NFT that provides an invitation, links to media containing message data, offers a coupon or discount, or the like. In a further implementation, a third party service may provide a mechanism for routing messages to users associated with blockchain wallet addresses based on the wallet address. The third party service may protect the contact addresses of the users but may enable the sending of communications based on a securely stored association at the third party service between contact addresses and wallet addresses.

The content of the notification generated and set to the filtered wallet addresses, or to contact addresses associated with the filtered wallet addresses, may be based on the one or more criteria used in segmenting and clustering users to form the set of users. To refer to the earlier example, if the criteria related to affinity for running shoes, then the content of the notification may be related to running shoes. In another example, the set of users may have been clustered based on measured interest in a particular recording artist and the content of the notification may be promotion or discount offer regarding a new release, concert, merchandise, etc., associated with the particular recording artist or a similar recording artist.

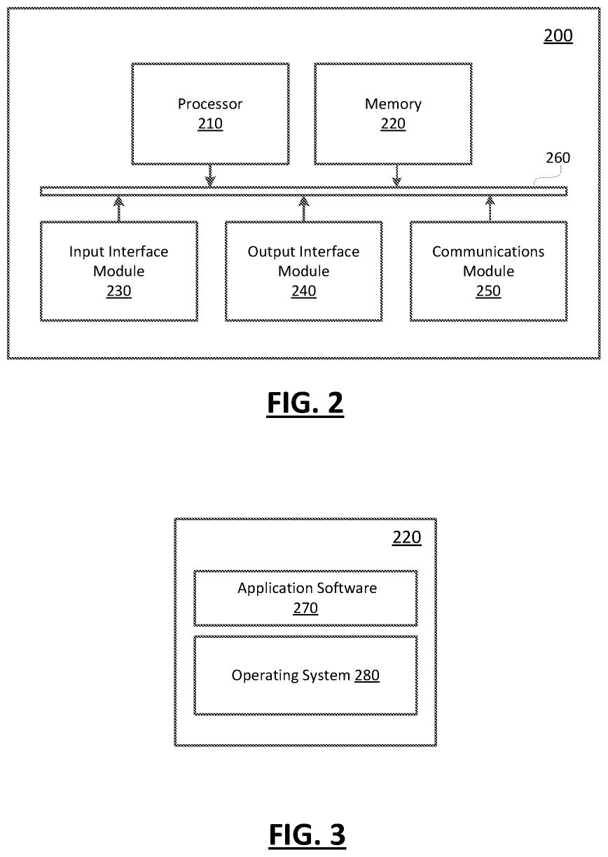

The e-commerce system 1004 and/or the user devices 1002 may be implemented using one or more computing devices. FIG. 2 is a high-level diagram of an example computing device 200. The example computing device 200 includes a variety of modules. For example, the example computing device 200 may include a processor 210, a memory 220, an input interface module 230, an output interface module 240, and a communications module 250. As illustrated, the foregoing example modules of the example computing device 200 are in communication over a bus 260.

The processor 210 is a hardware processor. The processor 210 may, for example, be one or more ARM, Intel x86, PowerPC processors, or the like.

The memory 220 allows data to be stored and retrieved. The memory 220 may include, for example, random access memory, read-only memory, and persistent storage. Persistent storage may be, for example, flash memory, a solid-state drive or the like. Read-only memory and persistent storage are a computer-readable medium. A computer-readable medium may be organized using a file system such as may be administered by an operating system governing overall operation of the example computing device 200.

The input interface module 230 allows the example computing device 200 to receive input signals. Input signals may, for example, correspond to input received from a user. The input interface module 230 may serve to interconnect the example computing device 200 with one or more input devices. Input signals may be received from input devices by the input interface module 230. Input devices may, for example, include one or more of a touchscreen input, keyboard, trackball or the like. In some embodiments, all or a portion of the input interface module 230 may be integrated with an input device. For example, the input interface module 230 may be integrated with one of the aforementioned example input devices.

The output interface module 240 allows the example computing device 200 to provide output signals. Some output signals may, for example, allow provision of output to a user. The output interface module 240 may serve to interconnect the example computing device 200 with one or more output devices. Output signals may be sent to output devices by output interface module 240. Output devices may include, for example, a display screen such as, for example, a liquid crystal display (LCD), a touchscreen display. Additionally, or alternatively, output devices may include devices other than screens such as, for example, a speaker, indicator lamps (such as, for example, light-emitting diodes (LEDs)), and printers. In some embodiments, all or a portion of the output interface module 240 may be integrated with an output device. For example, the output interface module 240 may be integrated with one of the aforementioned example output devices.

The communications module 250 allows the example computing device 200 to communicate with other electronic devices and/or various communications networks. For example, the communications module 250 may allow the example computing device 200 to send or receive communications signals. Communications signals may be sent or received according to one or more protocols or according to one or more standards. For example, the communications module 250 may allow the example computing device 200 to communicate via a cellular data network, such as for example, according to one or more standards such as, for example, Global System for Mobile Communications (GSM), Code Division Multiple Access (CDMA), Evolution Data Optimized (EVDO), Long-term Evolution (LTE) or the like. Additionally, or alternatively, the communications module 250 may allow the example computing device 200 to communicate using near-field communication (NFC), via Wi-Fi™, via the Ethernet family of network protocols, using Bluetooth™ or via some combination of one or more networks or protocols. Contactless payments may be made using NFC. In some embodiments, all or a portion of the communications module 250 may be integrated into a component of the example computing device 200. For example, the communications module may be integrated into a communications chipset.

Software instructions are executed by the processor 210 from a computer-readable medium. For example, software may be loaded into random-access memory from persistent storage within memory 220. Additionally, or alternatively, instructions may be executed by the processor 210 directly from read-only memory of the memory 220.

FIG. 3 depicts a simplified organization of software components stored in memory 220 of the example computing device 200. As illustrated, these software components include, at least, application software 270 and an operating system 280.

The application software 270 adapts the example computing device 200, in combination with the operating system 280, to operate as a device performing a particular function. While a single application software 270 is illustrated in FIG. 3, in operation, the memory 220 may include more than one application software and different application software may perform different operations. Example application software 270 includes the wallet application 1032 (FIG. 1), the web browser 1020 (FIG. 1), or the mobile application 1022 (FIG. 1).

The operating system 280 is software. The operating system 280 allows the application software 270 to access the processor 210, the memory 220, the input interface module 230, the output interface module 240 and the communications module 250. The operating system 280 may, for example, be iOS™, Android™, Linux™, Microsoft Windows™, or the like.

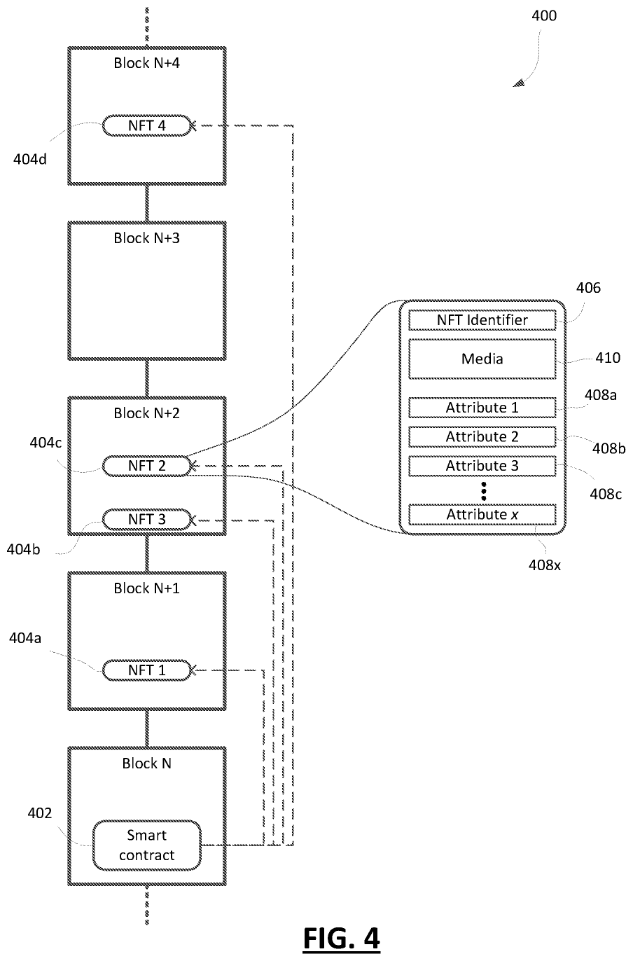

Reference is now made to FIG. 4, which illustrates an example blockchain 400. The blockchain 400 is a record of validated transactions grouped into blocks and successfully “mined” by one of the mining nodes within a blockchain network. Each block is immutable and is linked to the previous block by way of incorporating a hash of the previous block header within its own header. The functioning of a blockchain network and the variations possible under different blockchain protocols will be appreciated by those ordinarily skilled in the art.

A smart contract 402 may be implemented within the blockchain 400. In some cases, like with the Ethereum blockchain, the smart contract 402 may be executable code recorded on chain and may include functions that are available for execution by having those functions called in subsequent transactions. In this example, the smart contract 402 relates to NFT generation and/or management. That is, the smart contract 402 may have functions for minting NFTs, determining/validating ownership of those NFTs, transferring ownership of those NFTs from a current valid owner to a new owner. It will be appreciated that “ownership” is generally associated with an address, e.g. a public key value which may sometime be referred to as a wallet identifier or wallet address. A computing device that holds the corresponding private key may be used to authenticate the computing device as the owner of that public key, thereby enabling the computing device to take actions with respect to the “owned” NFT, such as transferring it to a different wallet address.

When the smart contract 402 is used to mint NFTs, the minting and ownership data for that NFT may be recorded on the blockchain 400, as indicated by 404a, 404b, 404c, 404d (collectively, 404). In some cases, the NFT data recorded on-chain includes, for example, a unique NFT identifier 406. In some instances, the NFT data recorded on-chain may include one or more media files 410 or URI link(s) to one or more media files that are the subject of the NFT. The media files 410 may include, for example, an image file, a video file, an audio file, or combinations thereof.

The NFT data may further include one or more NFT attributes 408 (shown as 408a, 408b, 408c, . . . , 408x). The NFT attributes 408 may include contextual information regarding the NFT, such as a minting date, a category, data regarding the features or characteristics of the media file 410, or any other such attributes of the subject matter of the NFT. The NFT attributes 408 may be in the form of a list of name-value pairs, a hierarchical tree of name-value pairs, a nested structure of attributes, a linked list, an array, or in any other suitable data structure format.

The NFTs 404 minted and managed by the smart contract 402 may be considered part of a collection of NFTs in that they are all governed by the same smart contract 402. In some cases, a collection of NFTs may be minted using different smart contracts or using non-blockchain code for generation of the NFTs and off-chain software for causing recordal of the NFTs on chain in blockchain transactions. Such NFTs may nevertheless be considered part of a single collection of NFTs if they are linked in such a manner as to form a collection, such as having a link or reference within each NFT identifying those NFTs as belonging to a specific collection. In one example, an NFT collection may have a single NFT.

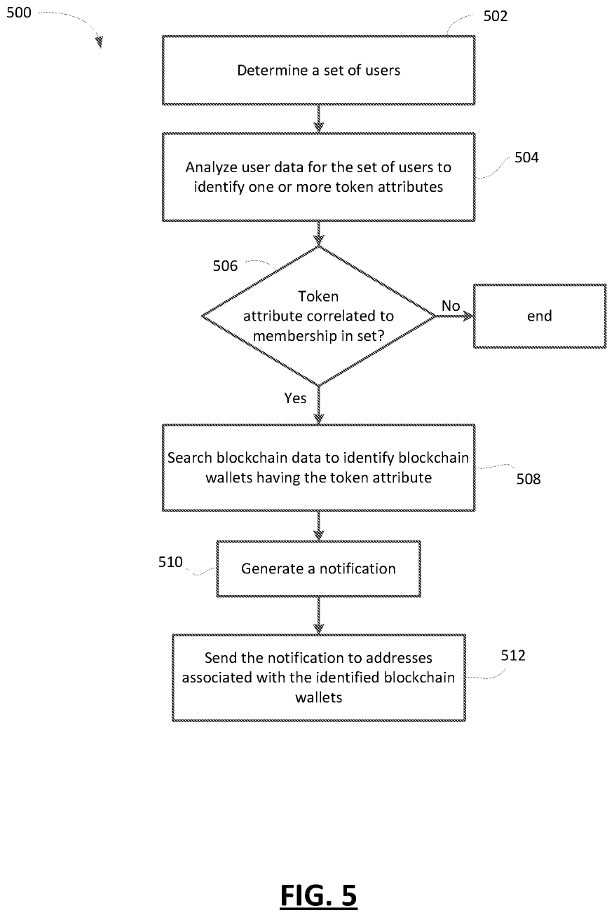

Reference will now be made to FIG. 5, which shows, in flowchart form, one example method 500 of generating and sending notifications to prospective users. The method 500 may be implemented by a multi-user computing platform, such as an e-commerce platform in some cases. In particular, the method 500 may be implemented by way of suitably-programmed software instructions stored in memory on a computing device which, when executed by one or more processors of the computing device, cause the computing device to carry out the described operations. In some cases, the method 500 may be implemented by one or more servers forming an e-commerce platform or system, such as the e-commerce system 1004 (FIG. 1). Although the following method 500 is described in the context of an e-commerce implementation, it will be appreciated that the operations of the method 500 may be generalized to apply in applications and contexts other than e-commerce.

In operation 502, the platform determines a set of users. As described above, the platform may have a plurality of registered users and a rich database of user data regarding those users and their past activity on the platform. In the case of a gaming system, the user data may include user contact data, user profile data, time engaged in gameplay, levels achieved, in-game purchases, interactions with other player characters, etc. In the case of an e-commerce system, the user data may include user contact data, user profile data, past transaction data, browsing history, wish lists, return history, etc. The users may be grouped or clustered based on one or more common features in order to form one or more sets. Membership in the set of users may be based on a common feature or characteristic of the users in that set. As examples, in the case of a gaming system, it may be a past purchase of an in-game power-up or special feature, or may be achievement of a certain player level or game level. In the case of an e-commerce system, example characteristics may be past or recent purchase of a particular item or class of product, or a browsing history with regard to a particular item or class of product.

The determination of the set of users may be performed by the platform or may be performed by another system and provided to the platform.

In operation 504, the platform analyzes the user data for the set of users to identify at least one token attribute. In particular, it analyzes blockchain wallet information within the user data. As noted above, in many cases the set of users may not all have connected a blockchain wallet such that the user data contains blockchain wallet information for a subset of the set of users. In some cases, the analysis may only proceed if the subset includes at least a minimum number of users, or if the subset includes at least a minimum percentage of the set of users.

In analyzing the blockchain wallet information, the platform is identifying a token attribute correlated to membership in the set of users. In some cases, the analysis may include identifying a token attribute common to all, or most, of the blockchain wallets associated with users in the set. In some cases, correlation may be determined by comparing blockchain wallet information for users in the set with blockchain wallet information for users not in the set. The platform may identify one or more candidate token attributes based on token attributes found in all or most of the wallets of users in the set, and may then calculate a correlation coefficient for each of the candidate token attributes to determine the strength of correlation between the attribute and membership in the set. In some cases, the platform may select the token attribute having the strongest correlation coefficient. In some cases, the platform may select more than one token attribute if there is more than one with a higher-than-threshold correlation coefficient for membership in the set. In some cases, the platform may select no token attribute if none of the token attributes have a correlation coefficient with a higher-than-threshold strength, e.g. magnitude.

The token attributes may be an attribute of token holdings of the wallets. For example, the attribute may be ownership of a minimum quantity of tokens, a minimum quantity of fungible tokens, a minimum count of NFTs, a particular type or class of NFT, an NFT from a particular NFT collection, an NFT having one or more certain NFT attributes, etc. In some cases, the token attributes may include an attribute of the token history of the wallets. For example, the attribute may be acquisition of an NFT or a particular type/class of NFT prior to a certain date, disposal/transfer of a previously-owned NFT of a certain type, a quantity of transactions in the wallet, a rate of transactions in the wallet, a history of transactions with one or more particular merchants/systems by the wallet, etc.

In operation 506, the platform determines whether it has identified a token attribute correlated to membership in the set of users. If not, then the method 500 ends; however, if one or more correlated token attributes are found, then in operation 508 the platform causes a search of blockchain data to identify blockchain wallets that feature the one or more token attributes. The search may be conducted by the platform directly on a copy of the blockchain, or on blockchain data obtained by the platform from a blockchain indexing service. The search may be conducted by sending a query to a blockchain node or a blockchain indexing service, wherein the query parameters include the one or more token attributes. The results of the query include one or more data identifying one or more blockchain wallets that have the one or more token attributes.

The platform generates a notification or other communication in operation 510, and sends the notification to addresses associated with the identified one or more blockchain wallets in operation 512. The notification may relate the common feature or characteristic that was used to form the set of users. For example, if the common feature was achievement of a certain game level, then the notification may relate to features or offers relevant to playing the game at that level. If the common feature was a past purchase of a particular type or class of product, then the notification may relate to a discount offer or upcoming release that is related to that particular type or class of product.

The addresses associated with the blockchain wallets may be the blockchain wallet addresses. The sending of the notification may include use of wallet-to-wallet messaging, if implemented by the blockchain wallet protocol governing the blockchain. In such circumstances, the platform may have its own blockchain wallet used for the purpose of sending messaging to other blockchain wallets. In one implementation, the notification may be in the form of an NFT, and the sending of the notification may include transferring the NFT to the blockchain wallets.

In some implementations, the addresses associated with the blockchain wallets may be other contact addresses, such as email addresses, text messaging addresses, social media handles, etc. The platform may obtain a plurality of non-blockchain addresses that map to the blockchain wallets. The non-blockchain addresses may be obtained from a third party service that maps contact blockchain wallet addresses to non-blockchain addresses.

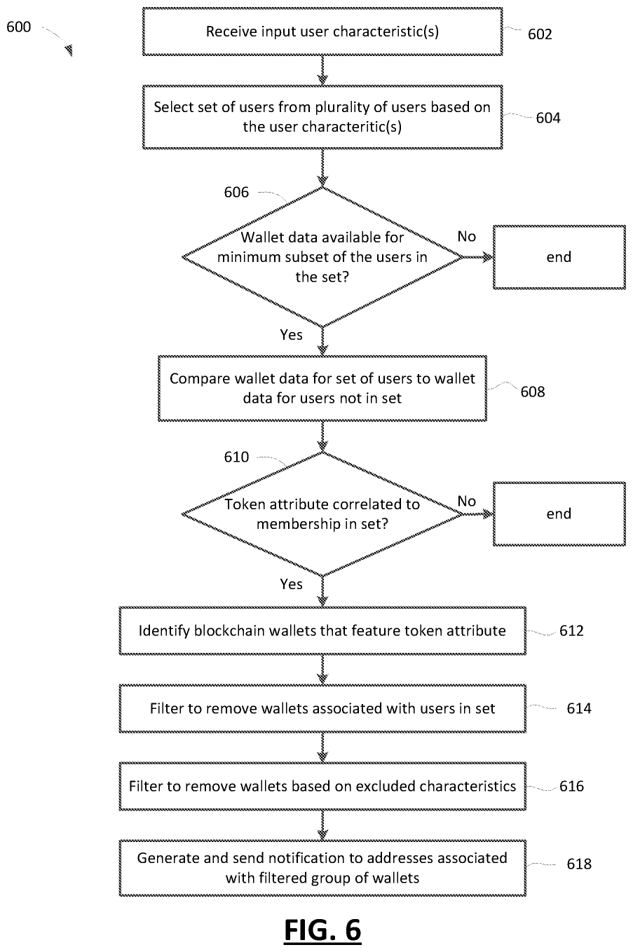

Reference is now made to FIG. 6, which shows, in flowchart form, one example method 600 of sending notifications to prospective users of a multi-user platform. The method 600 may be implemented by one or more servers or other computing devices forming the multi-user platform, such as the e-commerce system 1004 (FIG. 1). While the multi-user platform may be an e-commerce system in some embodiments, in other embodiments it may be another type of multi-user system, such as an online gaming system, a social media platform, an online media platform such as a streaming platform, or other such systems. In these examples, at least some of the existing users of the multi-user system have provided the system with blockchain wallet data. The system may obtain the blockchain wallet data from a user based on an exchange of data with a user device connected to the system, wherein the user device includes a wallet application that provides the system with at least a wallet address and a digital signature verifying possession by the user device of the private key corresponding to the wallet address. The wallet data may be provided to the system as part of a token-based access control operation in some cases.

The multi-user system had one or more databases of user data regarding known or registered users of the system. In some cases, the database includes a user record for each user containing data regarding that user, such as contact information, profile information, demographic data, transaction history, browsing history, posting history, etc. Some of the user records may include blockchain wallet data, such as at least one blockchain wallet address. The blockchain wallet data may include data regarding holdings or history of the blockchain wallet address, including tokens held, attributes of tokens held, transaction history of tokens received or transferred, etc.

In operation 602, the system receives at least one input user characteristic. The input user characteristic is a parameter or user detail that may be used as the basis for grouping or segmenting the users. That is, the input user characteristic may be used to identify a set of users from among the plurality of known or registered users of the multi-user system. The input user characteristic may be input by an administrator of the multi-user system in some cases. It may be input by a merchant user in the case of an e-commerce system in some implementations.

The input user characteristic may be, in an illustrative e-commerce example, a transaction involving a particular product or class of product in a recent time window, e.g. last 8 months. As another example, it may be past purchase of a concert ticket relating to a particular performer. As yet another example, it may be a browsing history showing more than 2 page views of a particular product item or class of product items in the past week.

At operation 604, the system selects the set of users based on the input user characteristic. The system may search its database of user data to identify user records that include the input user characteristic. In some cases, the input characteristic may include an excluded characteristic. For instance, the input user characteristic may include users that have a purchase transaction relating to a product item, but also exclude users that have a return transaction for that product item. The result of operation 604, is that the system has identified the set of users based on the input user characteristic.

In operation 606, the system determines how many of the users in the set of users have associated wallet data in the user data and, whether that count of users is large enough to carry out the method 600. Use of the method 600 may be conditional on there being at least a minimum subset of the set of users for which the system has wallet data. The minimum subset may be a minimum count of users or a minimum percentage of users. Both minimums may be applied in some cases. For example, the system may set a minimum count of one hundred users and a minimum percentage of 20%. To illustrate, if a set contains a thousand users, the condition of operation 606 may be that the subset of users for which the system has wallet data must be at least two hundred. If the set contains only four hundred users, the minimum subset must be at least one hundred. In some cases, the method 600 may continue if either minimum is satisfied rather than both.

In some cases, operation 606 may further include determining whether the system has wallet data for a sufficient number of users not in the set of users. That is, in order to assess the strength of correlation between a token attribute and membership in the set, the system may set a minimum number or percentage of users in the set for which it needs wallet data, and a minimum number or percentage of users outside of the set for which it needs wallet data. Those minimums may be the same or may be different.

In some implementations, the system may query the blockchain or a blockchain node or indexing service for up-to-date wallet data for each of the wallet addresses, e.g. so it has a complete and current record of each address' token holdings.

If there is a sufficient quantity of wallet data available to the system to continue, then in operation 608 the system compares wallet data for the users in the set of users to wallet data for users not in the set of users. In some cases, this includes identifying one or more token attributes included in many or most or all of the wallets associated with users in the set, and that are not included in many or most or all of the wallets associated with users not in the set. The system may identify one or more candidate token attributes based on token attributes detected in one or more of the wallets of users in the set, and may then calculate a correlation coefficient for each of the candidate token attributes to determine the strength of correlation between the attribute and membership in the set. In some cases, the system may select the token attribute having the strongest correlation coefficient. In some cases, the system may select more than one token attribute if there is more than one with a higher-than-threshold correlation coefficient for membership in the set. In some cases, the system may select no token attribute if none of the token attributes have a correlation coefficient with a higher-than-threshold strength, e.g. magnitude.

As indicated by operation 610, if the system cannot identify a token attribute correlated to membership in the set, then the method 600 may end. If one or more token attributes is identified in operation 608 and confirmed to be correlated to membership in operation 610, then in operation 612 the system identifies, based on blockchain data for the blockchain, a plurality of blockchain wallet addresses that feature the one or more identified token attributes. Operation 610 may include initiating a search of the blockchain. The system may have a copy of the blockchain through which it can search for wallet addresses having the requisite token attribute(s). In some cases, the system may query a blockchain node or a blockchain indexing service for a set of wallet addresses having the requisite token attribute(s).

In operation 614, the system filters the wallet addresses to remove any wallet addresses already known to the system to be associated with a user for which it has a user record. In some cases, this may include excluding wallet addresses associated with any users in the set of users. In some cases, this may include excluding wallet addresses associated with any user of the system, whether in the set or excluded from the set. This operation may be subsumed into the previous operation in some implementations. It may be omitted in some implementations.

In operation 616, the system may further filter the wallet addresses to remove certain addresses based on exclusion criteria. In trying to identify prospective users, the system may be configured to exclude certain addresses unlikely to be associated with prospective users. For example, minting wallets designed to hold initially minted tokens prior to distribution and burn wallets designed to hold ‘burnt’ or ‘exhausted’ tokens are types of wallets that may be excluded. The system may also exclude wallets that appear to be associated with certain types of activity. For instance, wallets that have a measurably large transaction count for NFTs may include a user engaged in token speculation rather than genuine interest in the subject of the tokens. In some cases, transactions in tokens at a nominal value may indicate a temporary wallet used by the holder as a pass-through wallet. Identification of some of these types or classes of wallets may be based on characteristics of the transaction history, e.g. a rate of transactions, nominal value transactions, etc.

Once the wallet addresses obtained from the blockchain have been filtered, then in operation 618 the system generates and sends a notification to addresses associated with those wallets. The addresses may be the wallet addresses themselves or may be other contact addresses mapped to the wallet addresses. The notification may be a message sent to the wallet address using a wallet-to-wallet messaging function. The notification may be a token containing message data that is transferred to the wallet addresses. The system may obtain contact addresses from a third-party service that maps contact addresses to wallet addresses to enable messaging to blockchain wallet holders.

In any of the above-described example methods or processes it will be understood that certain operations described as occurring in sequence may be implemented in a different sequence or carried out in parallel without impacting the overall functioning of the method or process.

### Example E-commerce Platform

Although integration with a commerce platform is not required, in some embodiments, the methods disclosed herein may be performed on or in association with a commerce platform such as an e-commerce platform. Therefore, an example of a commerce platform will be described.

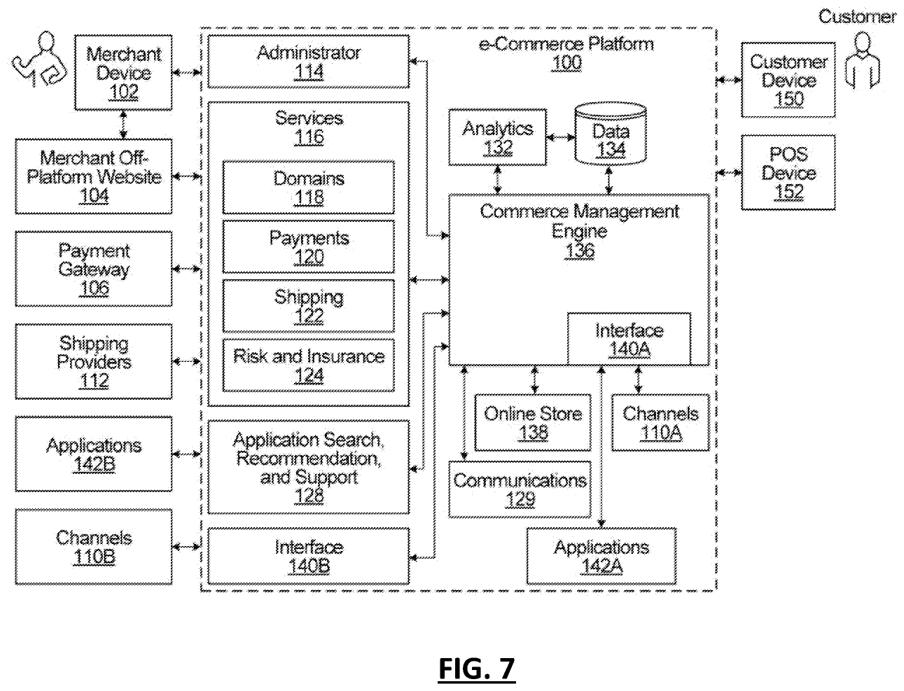

FIG. 7 illustrates an example e-commerce platform 100, according to one embodiment. The e-commerce platform 100 may be exemplary of the e-commerce system 1004 described with reference to FIG. 1. The e-commerce platform 100 may be used to provide merchant products and services to customers. While the disclosure contemplates using the apparatus, system, and process to purchase products and services, for simplicity the description herein will refer to products. All references to products throughout this disclosure should also be understood to be references to products and/or services, including, for example, physical products, digital content (e.g., music, videos, games), software, tickets, subscriptions, services to be provided, and the like.

While the disclosure throughout contemplates that a “merchant” and a “customer” may be more than individuals, for simplicity the description herein may generally refer to merchants and customers as such. All references to merchants and customers throughout this disclosure should also be understood to be references to groups of individuals, companies, corporations, computing entities, and the like, and may represent for-profit or not-for-profit exchange of products. Further, while the disclosure throughout refers to “merchants” and “customers”, and describes their roles as such, the e-commerce platform 100 should be understood to more generally support users in an e-commerce environment, and all references to merchants and customers throughout this disclosure should also be understood to be references to users, such as where a user is a merchant-user (e.g., a seller, retailer, wholesaler, or provider of products), a customer-user (e.g., a buyer, purchase agent, consumer, or user of products), a prospective user (e.g., a user browsing and not yet committed to a purchase, a user evaluating the e-commerce platform 100 for potential use in marketing and selling products, and the like), a service provider user (e.g., a shipping provider 112, a financial provider, and the like), a company or corporate user (e.g., a company representative for purchase, sales, or use of products; an enterprise user; a customer relations or customer management agent, and the like), an information technology user, a computing entity user (e.g., a computing bot for purchase, sales, or use of products), and the like. Furthermore, it may be recognized that while a given user may act in a given role (e.g., as a merchant) and their associated device may be referred to accordingly (e.g., as a merchant device) in one context, that same individual may act in a different role in another context (e.g., as a customer) and that same or another associated device may be referred to accordingly (e.g., as a customer device). For example, an individual may be a merchant for one type of product (e.g., shoes), and a customer/consumer of other types of products (e.g., groceries). In another example, an individual may be both a consumer and a merchant of the same type of product. In a particular example, a merchant that trades in a particular category of goods may act as a customer for that same category of goods when they order from a wholesaler (the wholesaler acting as merchant).

The e-commerce platform 100 provides merchants with online services/facilities to manage their business. The facilities described herein are shown implemented as part of the platform 100 but could also be configured separately from the platform 100, in whole or in part, as stand-alone services. Furthermore, such facilities may, in some embodiments, may, additionally or alternatively, be provided by one or more providers/entities.

In the example of FIG. 7, the facilities are deployed through a machine, service or engine that executes computer software, modules, program codes, and/or instructions on one or more processors which, as noted above, may be part of or external to the platform 100. Merchants may utilize the e-commerce platform 100 for enabling or managing commerce with customers, such as by implementing an e-commerce experience with customers through an online store 138, applications 142A-B, channels 110A-B, and/or through point-of-sale (POS) devices 152 in physical locations (e.g., a physical storefront or other location such as through a kiosk, terminal, reader, printer, 3D printer, and the like). The example computing device 200 of FIG. 1 may be exemplary of each POS device 152.

A merchant may utilize the e-commerce platform 100 as a sole commerce presence with customers, or in conjunction with other merchant commerce facilities, such as through a physical store (e.g., “brick-and-mortar” retail stores), a merchant off-platform website 104 (e.g., a commerce Internet website or other internet or web property or asset supported by or on behalf of the merchant separately from the e-commerce platform 100), an application 142B, and the like. However, even these “other” merchant commerce facilities may be incorporated into or communicate with the e-commerce platform 100, such as where POS devices 152 in a physical store of a merchant are linked into the e-commerce platform 100, where a merchant off-platform website 104 is tied into the e-commerce platform 100, such as, for example, through “buy buttons” that link content from the merchant off platform website 104 to the online store 138, or the like.

The online store 138 may represent a multi-tenant facility comprising a plurality of virtual storefronts. In embodiments, merchants may configure and/or manage one or more storefronts in the online store 138, such as, for example, through a merchant device 102 (e.g., computer, laptop computer, mobile computing device, and the like), and offer products to customers through a number of different channels 110A-B (e.g., an online store 138; an application 142A-B; a physical storefront through a POS device 152; an electronic marketplace, such, for example, through an electronic buy button integrated into a website or social media channel such as on a social network, social media page, social media messaging system; and/or the like). A merchant may sell across channels 110A-B and then manage their sales through the e-commerce platform 100, where channels 110A may be provided as a facility or service internal or external to the e-commerce platform 100. A merchant may, additionally or alternatively, sell in their physical retail store, at pop ups, through wholesale, over the phone, and the like, and then manage their sales through the e-commerce platform 100. A merchant may employ all or any combination of these operational modalities. Notably, it may be that by employing a variety of and/or a particular combination of modalities, a merchant may improve the probability and/or volume of sales. Throughout this disclosure the terms online store 138 and storefront may be used synonymously to refer to a merchant's online e-commerce service offering through the e-commerce platform 100, where an online store 138 may refer either to a collection of storefronts supported by the e-commerce platform 100 (e.g., for one or a plurality of merchants) or to an individual merchant's storefront (e.g., a merchant's online store).

In some embodiments, a customer may interact with the platform 100 through a customer device 150 (e.g., computer, laptop computer, mobile computing device, or the like), a POS device 152 (e.g., retail device, kiosk, automated (self-service) checkout system, or the like), and/or any other commerce interface device known in the art. The e-commerce platform 100 may enable merchants to reach customers through the online store 138, through applications 142A-B, through POS devices 152 in physical locations (e.g., a merchant's storefront or elsewhere), to communicate with customers via electronic communication facility 129, and/or the like so as to provide a system for reaching customers and facilitating merchant services for the real or virtual pathways available for reaching and interacting with customers.

In some embodiments, and as described further herein, the e-commerce platform 100 may be implemented through a processing facility. Such a processing facility may include a processor and a memory. The processor may be a hardware processor. The memory may be and/or may include a non-transitory computer-readable medium. The memory may be and/or may include random access memory (RAM) and/or persisted storage (e.g., magnetic storage). The processing facility may store a set of instructions (e.g., in the memory) that, when executed, cause the e-commerce platform 100 to perform the e-commerce and support functions as described herein. The processing facility may be or may be a part of one or more of a server, client, network infrastructure, mobile computing platform, cloud computing platform, stationary computing platform, and/or some other computing platform, and may provide electronic connectivity and communications between and amongst the components of the e-commerce platform 100, merchant devices 102, payment gateways 106, applications 142A-B, channels 110A-B, shipping providers 112, customer devices 150, point-of-sale devices 152, etc. In some implementations, the processing facility may be or may include one or more such computing devices acting in concert. For example, it may be that a plurality of co-operating computing devices serves as/to provide the processing facility. The e-commerce platform 100 may be implemented as or using one or more of a cloud computing service, software as a service (SaaS), infrastructure as a service (IaaS), platform as a service (PaaS), desktop as a service (DaaS), managed software as a service (MSaaS), mobile backend as a service (MBaaS), information technology management as a service (ITMaaS), and/or the like. For example, it may be that the underlying software implementing the facilities described herein (e.g., the online store 138) is provided as a service, and is centrally hosted (e.g., and then accessed by users via a web browser or other application, and/or through customer devices 150, POS devices 152, and/or the like). In some embodiments, elements of the e-commerce platform 100 may be implemented to operate and/or integrate with various other platforms and operating systems.

In some embodiments, the facilities of the e-commerce platform 100 (e.g., the online store 138) may serve content to a customer device 150 (using data 134) such as, for example, through a network connected to the e-commerce platform 100. For example, the online store 138 may serve or send content in response to requests for data 134 from the customer device 150, where a browser (or other application) connects to the online store 138 through a network using a network communication protocol (e.g., an internet protocol). The content may be written in machine readable language and may include Hypertext Markup Language (HTML), template language, JavaScript, and the like, and/or any combination thereof.

In some embodiments, online store 138 may be or may include service instances that serve content to customer devices and allow customers to browse and purchase the various products available (e.g., add them to a cart, purchase through a buy-button, and the like). Merchants may also customize the look and feel of their website through a theme system, such as, for example, a theme system where merchants can select and change the look and feel of their online store 138 by changing their theme while having the same underlying product and business data shown within the online store's product information. It may be that themes can be further customized through a theme editor, a design interface that enables users to customize their website's design with flexibility. Additionally, or alternatively, it may be that themes can, additionally or alternatively, be customized using theme-specific settings such as, for example, settings as may change aspects of a given theme, such as, for example, specific colors, fonts, and pre-built layout schemes. In some implementations, the online store may implement a content management system for website content. Merchants may employ such a content management system in authoring blog posts or static pages and publish them to their online store 138, such as through blogs, articles, landing pages, and the like, as well as configure navigation menus. Merchants may upload images (e.g., for products), video, content, data, and the like to the e-commerce platform 100, such as for storage by the system (e.g., as data 134). In some embodiments, the e-commerce platform 100 may provide functions for manipulating such images and content such as, for example, functions for resizing images, associating an image with a product, adding and associating text with an image, adding an image for a new product variant, protecting images, and the like.

As described herein, the e-commerce platform 100 may provide merchants with sales and marketing services for products through a number of different channels 110A-B, including, for example, the online store 138, applications 142A-B, as well as through physical POS devices 152 as described herein. The e-commerce platform 100 may, additionally or alternatively, include business support services 116, an administrator 114, a warehouse management system, and the like associated with running an on-line business, such as, for example, one or more of providing a domain registration service 118 associated with their online store, payment facility 120 for facilitating transactions with a customer, shipping services 122 for providing customer shipping options for purchased products, fulfillment services for managing inventory, risk and insurance services 124 associated with product protection and liability, merchant billing, and the like. Services 116 may be provided via the e-commerce platform 100 or in association with external facilities, such as through a payment gateway 106 for payment processing, shipping providers 112 for expediting the shipment of products, and the like.

In some embodiments, the e-commerce platform 100 may be configured with shipping services 122 (e.g., through an e-commerce platform shipping facility or through a third-party shipping carrier), to provide various shipping-related information to merchants and/or their customers such as, for example, shipping label or rate information, real-time delivery updates, tracking, and/or the like.

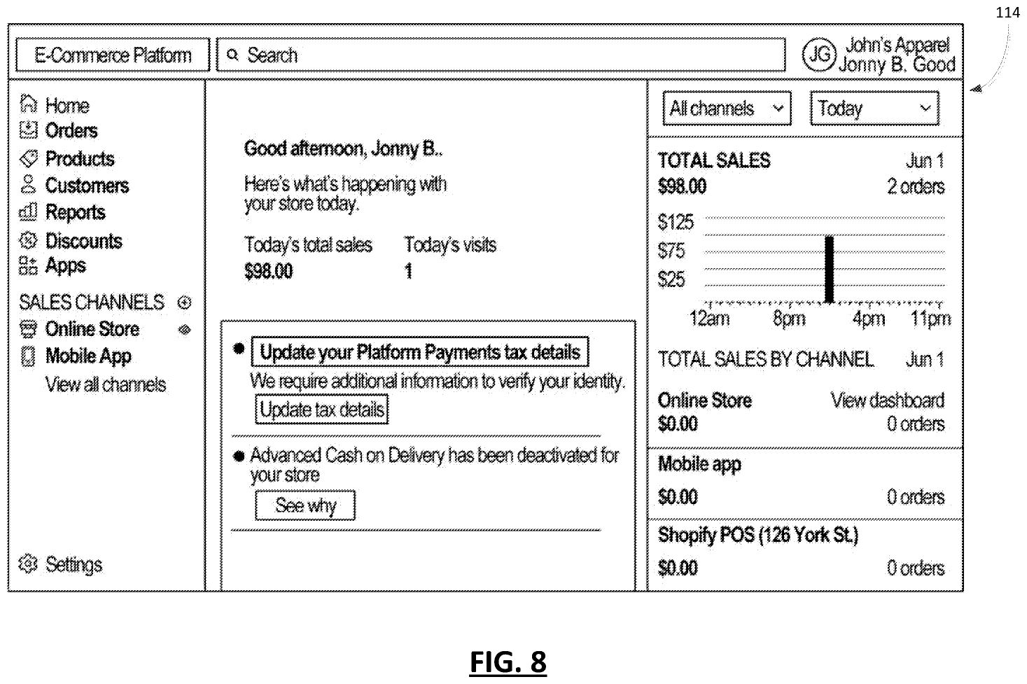

FIG. 8 depicts a non-limiting embodiment for a home page of an administrator 114. The administrator 114 may be referred to as an administrative console and/or an administrator console. The administrator 114 may show information about daily tasks, a store's recent activity, and the next steps a merchant can take to build their business. In some embodiments, a merchant may log in to the administrator 114 via a merchant device 102 (e.g., a desktop computer or mobile device), and manage aspects of their online store 138, such as, for example, viewing the online store's 138 recent visit or order activity, updating the online store's 138 catalog, managing orders, and/or the like. In some embodiments, the merchant may be able to access the different sections of the administrator 114 by using a sidebar, such as the one shown on FIG. 8. Sections of the administrator 114 may include various interfaces for accessing and managing core aspects of a merchant's business, including orders, products, customers, available reports and discounts. The administrator 114 may, additionally or alternatively, include interfaces for managing sales channels for a store including the online store 138, mobile application(s) made available to customers for accessing the store (Mobile App), POS devices, and/or a buy button. The administrator 114 may, additionally or alternatively, include interfaces for managing applications (apps) installed on the merchant's account; and settings applied to a merchant's online store 138 and account. A merchant may use a search bar to find products, pages, or other information in their store.

More detailed information about commerce and visitors to a merchant's online store 138 may be viewed through reports or metrics. Reports may include, for example, acquisition reports, behavior reports, customer reports, finance reports, marketing reports, sales reports, product reports, and custom reports. The merchant may be able to view sales data for different channels 110A-B from different periods of time (e.g., days, weeks, months, and the like), such as by using drop-down menus. An overview dashboard may also be provided for a merchant who wants a more detailed view of the store's sales and engagement data. An activity feed in the home metrics section may be provided to illustrate an overview of the activity on the merchant's account. For example, by clicking on a “view all recent activity” dashboard button, the merchant may be able to see a longer feed of recent activity on their account. A home page may show notifications about the merchant's online store 138, such as based on account status, growth, recent customer activity, order updates, and the like. Notifications may be provided to assist a merchant with navigating through workflows configured for the online store 138, such as, for example, a payment workflow, an order fulfillment workflow, an order archiving workflow, a return workflow, and the like.

The e-commerce platform 100 may provide for a communications facility 129 and associated merchant interface for providing electronic communications and marketing, such as utilizing an electronic messaging facility for collecting and analyzing communication interactions between merchants, customers, merchant devices 102, customer devices 150, POS devices 152, and the like, to aggregate and analyze the communications, such as for increasing sale conversions, and the like. For instance, a customer may have a question related to a product, which may produce a dialog between the customer and the merchant (or an automated processor-based agent/chatbot representing the merchant), where the communications facility 129 is configured to provide automated responses to customer requests and/or provide recommendations to the merchant on how to respond such as, for example, to improve the probability of a sale.

The e-commerce platform 100 may provide a financial facility 120 for secure financial transactions with customers, such as through a secure card server environment. The e-commerce platform 100 may store credit card information, such as in payment card industry data (PCI) environments (e.g., a card server), to reconcile financials, bill merchants, perform automated clearing house (ACH) transfers between the e-commerce platform 100 and a merchant's bank account, and the like. The financial facility 120 may also provide merchants and buyers with financial support, such as through the lending of capital (e.g., lending funds, cash advances, and the like) and provision of insurance. In some embodiments, online store 138 may support a number of independently administered storefronts and process a large volume of transactional data on a daily basis for a variety of products and services. Transactional data may include any customer information indicative of a customer, a customer account or transactions carried out by a customer such as, for example, contact information, billing information, shipping information, returns/refund information, discount/offer information, payment information, or online store events or information such as page views, product search information (search keywords, click-through events), product reviews, abandoned carts, and/or other transactional information associated with business through the e-commerce platform 100. In some embodiments, the e-commerce platform 100 may store this data in a data facility 134. Referring again to FIG. 7, in some embodiments the e-commerce platform 100 may include a commerce management engine 136 such as may be configured to perform various workflows for task automation or content management related to products, inventory, customers, orders, suppliers, reports, financials, risk and fraud, and the like. In some embodiments, additional functionality may, additionally or alternatively, be provided through applications 142A-B to enable greater flexibility and customization required for accommodating an ever-growing variety of online stores, POS devices, products, and/or services. Applications 142A may be components of the e-commerce platform 100 whereas applications 142B may be provided or hosted as a third-party service external to e-commerce platform 100. The commerce management engine 136 may accommodate store-specific workflows and in some embodiments, may incorporate the administrator 114 and/or the online store 138.

Implementing functions as applications 142A-B may enable the commerce management engine 136 to remain responsive and reduce or avoid service degradation or more serious infrastructure failures, and the like.

Although isolating online store data can be important to maintaining data privacy between online stores 138 and merchants, there may be reasons for collecting and using cross-store data, such as, for example, with an order risk assessment system or a platform payment facility, both of which require information from multiple online stores 138 to perform well. In some embodiments, it may be preferable to move these components out of the commerce management engine 136 and into their own infrastructure within the e-commerce platform 100.

Platform payment facility 120 is an example of a component that utilizes data from the commerce management engine 136 but is implemented as a separate component or service. The platform payment facility 120 may allow customers interacting with online stores 138 to have their payment information stored safely by the commerce management engine 136 such that they only have to enter it once. When a customer visits a different online store 138, even if they have never been there before, the platform payment facility 120 may recall their information to enable a more rapid and/or potentially less-error prone (e.g., through avoidance of possible mis-keying of their information if they needed to instead re-enter it) checkout. This may provide a cross-platform network effect, where the e-commerce platform 100 becomes more useful to its merchants and buyers as more merchants and buyers join, such as because there are more customers who checkout more often because of the ease of use with respect to customer purchases. To maximize the effect of this network, payment information for a given customer may be retrievable and made available globally across multiple online stores 138.

For functions that are not included within the commerce management engine 136, applications 142A-B provide a way to add features to the e-commerce platform 100 or individual online stores 138. For example, applications 142A-B may be able to access and modify data on a merchant's online store 138, perform tasks through the administrator 114, implement new flows for a merchant through a user interface (e.g., that is surfaced through extensions/API), and the like. Merchants may be enabled to discover and install applications 142A-B through application search, recommendations, and support 128. In some embodiments, the commerce management engine 136, applications 142A-B, and the administrator 114 may be developed to work together. For instance, application extension points may be built inside the commerce management engine 136, accessed by applications 142A and 142B through the interfaces 140B and 140A to deliver additional functionality, and surfaced to the merchant in the user interface of the administrator 114.

In some embodiments, applications 142A-B may deliver functionality to a merchant through the interface 140A-B, such as where an application 142A-B is able to surface transaction data to a merchant (e.g., App: “Engine, surface my app data in the Mobile App or administrator 114”), and/or where the commerce management engine 136 is able to ask the application to perform work on demand (Engine: “App, give me a local tax calculation for this checkout”).

Applications 142A-B may be connected to the commerce management engine 136 through an interface 140A-B (e.g., through REST (REpresentational State Transfer) and/or GraphQL APIs) to expose the functionality and/or data available through and within the commerce management engine 136 to the functionality of applications. For instance, the e-commerce platform 100 may provide API interfaces 140A-B to applications 142A-B which may connect to products and services external to the platform 100. The flexibility offered through use of applications and APIs (e.g., as offered for application development) enable the e-commerce platform 100 to better accommodate new and unique needs of merchants or to address specific use cases without requiring constant change to the commerce management engine 136. For instance, shipping services 122 may be integrated with the commerce management engine 136 through a shipping or carrier service API, thus enabling the e-commerce platform 100 to provide shipping service functionality without directly impacting code running in the commerce management engine 136.

Depending on the implementation, applications 142A-B may utilize APIs to pull data on demand (e.g., customer creation events, product change events, or order cancellation events, etc.) or have the data pushed when updates occur. A subscription model may be used to provide applications 142A-B with events as they occur or to provide updates with respect to a changed state of the commerce management engine 136. In some embodiments, when a change related to an update event subscription occurs, the commerce management engine 136 may post a request, such as to a predefined callback URL. The body of this request may contain a new state of the object and a description of the action or event. Update event subscriptions may be created manually, in the administrator facility 114, or automatically (e.g., via the API 140A-B). In some embodiments, update events may be queued and processed asynchronously from a state change that triggered them, which may produce an update event notification that is not distributed in real-time or near-real time.

In some embodiments, the e-commerce platform 100 may provide one or more of application search, recommendation and support 128. Application search, recommendation and support 128 may include developer products and tools to aid in the development of applications, an application dashboard (e.g., to provide developers with a development interface, to administrators for management of applications, to merchants for customization of applications, and the like), facilities for installing and providing permissions with respect to providing access to an application 142A-B (e.g., for public access, such as where criteria must be met before being installed, or for private use by a merchant), application searching to make it easy for a merchant to search for applications 142A-B that satisfy a need for their online store 138, application recommendations to provide merchants with suggestions on how they can improve the user experience through their online store 138, and the like. In some embodiments, applications 142A-B may be assigned an application identifier (ID), such as for linking to an application (e.g., through an API), searching for an application, making application recommendations, and the like.

Applications 142A-B may be grouped roughly into three categories: customer-facing applications, merchant-facing applications, integration applications, and the like. Customer-facing applications 142A-B may include an online store 138 or channels 110A-B that are places where merchants can list products and have them purchased (e.g., the online store, applications for flash sales (e.g., merchant products or from opportunistic sales opportunities from third-party sources), a mobile store application, a social media channel, an application for providing wholesale purchasing, and the like). Merchant-facing applications 142A-B may include applications that allow the merchant to administer their online store 138 (e.g., through applications related to the web or website or to mobile devices), run their business (e.g., through applications related to POS devices), to grow their business (e.g., through applications related to shipping (e.g., drop shipping), use of automated agents, use of process flow development and improvements), and the like. Integration applications may include applications that provide useful integrations that participate in the running of a business, such as shipping providers 112 and payment gateways 106.

As such, the e-commerce platform 100 can be configured to provide an online shopping experience through a flexible system architecture that enables merchants to connect with customers in a flexible and transparent manner. A typical customer experience may be better understood through an embodiment example purchase workflow, where the customer browses the merchant's products on a channel 110A-B, adds what they intend to buy to their cart, proceeds to checkout, and pays for the content of their cart resulting in the creation of an order for the merchant. The merchant may then review and fulfill (or cancel) the order. The product is then delivered to the customer. If the customer is not satisfied, they might return the products to the merchant.

In an example embodiment, a customer may browse a merchant's products through a number of different channels 110A-B such as, for example, the merchant's online store 138, a physical storefront through a POS device 152; an electronic marketplace, through an electronic buy button integrated into a website or a social media channel). In some cases, channels 110A-B may be modeled as applications 142A-B. A merchandising component in the commerce management engine 136 may be configured for creating, and managing product listings (using product data objects or models for example) to allow merchants to describe what they want to sell and where they sell it. The association between a product listing and a channel may be modeled as a product publication and accessed by channel applications, such as via a product listing API. A product may have many attributes and/or characteristics, like size and color, and many variants that expand the available options into specific combinations of all the attributes, like a variant that is size extra-small and green, or a variant that is size large and blue. Products may have at least one variant (e.g., a “default variant”) created for a product without any options. To facilitate browsing and management, products may be grouped into collections, provided product identifiers (e.g., stock keeping unit (SKU)) and the like. Collections of products may be built by either manually categorizing products into one (e.g., a custom collection), by building rulesets for automatic classification (e.g., a smart collection), and the like. Product listings may include 2D images, 3D images or models, which may be viewed through a virtual or augmented reality interface, and the like.

In some embodiments, a shopping cart object is used to store or keep track of the products that the customer intends to buy. The shopping cart object may be channel specific and can be composed of multiple cart line items, where each cart line item tracks the quantity for a particular product variant. Since adding a product to a cart does not imply any commitment from the customer or the merchant, and the expected lifespan of a cart may be in the order of minutes (not days), cart objects/data representing a cart may be persisted to an ephemeral data store.

The customer then proceeds to checkout. A checkout object or page generated by the commerce management engine 136 may be configured to receive customer information to complete the order such as the customer's contact information, billing information and/or shipping details. If the customer inputs their contact information but does not proceed to payment, the e-commerce platform 100 may (e.g., via an abandoned checkout component) transmit a message to the customer device 150 to encourage the customer to complete the checkout. For those reasons, checkout objects can have much longer lifespans than cart objects (hours or even days) and may therefore be persisted. Customers then pay for the content of their cart resulting in the creation of an order for the merchant. In some embodiments, the commerce management engine 136 may be configured to communicate with various payment gateways and services 106 (e.g., online payment systems, mobile payment systems, digital wallets, credit card gateways) via a payment processing component. The actual interactions with the payment gateways 106 may be provided through a card server environment. At the end of the checkout process, an order is created. An order is a contract of sale between the merchant and the customer where the merchant agrees to provide the goods and services listed on the order (e.g., order line items, shipping line items, and the like) and the customer agrees to provide payment (including taxes). Once an order is created, an order confirmation notification may be sent to the customer and an order placed notification sent to the merchant via a notification component. Inventory may be reserved when a payment processing job starts to avoid over-selling (e.g., merchants may control this behavior using an inventory policy or configuration for each variant). Inventory reservation may have a short time span (minutes) and may need to be fast and scalable to support flash sales or “drops”, which are events during which a discount, promotion or limited inventory of a product may be offered for sale for buyers in a particular location and/or for a particular (usually short) time. The reservation is released if the payment fails. When the payment succeeds, and an order is created, the reservation is converted into a permanent (long-term) inventory commitment allocated to a specific location. An inventory component of the commerce management engine 136 may record where variants are stocked, and may track quantities for variants that have inventory tracking enabled. It may decouple product variants (a customer-facing concept representing the template of a product listing) from inventory items (a merchant-facing concept that represents an item whose quantity and location is managed). An inventory level component may keep track of quantities that are available for sale, committed to an order or incoming from an inventory transfer component (e.g., from a vendor).

The merchant may then review and fulfill (or cancel) the order. A review component of the commerce management engine 136 may implement a business process merchant's use to ensure orders are suitable for fulfillment before actually fulfilling them. Orders may be fraudulent, require verification (e.g., ID checking), have a payment method which requires the merchant to wait to make sure they will receive their funds, and the like. Risks and recommendations may be persisted in an order risk model. Order risks may be generated from a fraud detection tool, submitted by a third-party through an order risk API, and the like. Before proceeding to fulfillment, the merchant may need to capture the payment information (e.g., credit card information) or wait to receive it (e.g., via a bank transfer, check, and the like) before it marks the order as paid. The merchant may now prepare the products for delivery. In some embodiments, this business process may be implemented by a fulfillment component of the commerce management engine 136. The fulfillment component may group the line items of the order into a logical fulfillment unit of work based on an inventory location and fulfillment service. The merchant may review, adjust the unit of work, and trigger the relevant fulfillment services, such as through a manual fulfillment service (e.g., at merchant managed locations) used when the merchant picks and packs the products in a box, purchase a shipping label and input its tracking number, or just mark the item as fulfilled. Alternatively, an API fulfillment service may trigger a third-party application or service to create a fulfillment record for a third-party fulfillment service. Other possibilities exist for fulfilling an order. If the customer is not satisfied, they may be able to return the product(s) to the merchant. The business process merchants may go through to “un-sell” an item may be implemented by a return component. Returns may consist of a variety of different actions, such as a restock, where the product that was sold actually comes back into the business and is sellable again; a refund, where the money that was collected from the customer is partially or fully returned; an accounting adjustment noting how much money was refunded (e.g., including if there was any restocking fees or goods that weren't returned and remain in the customer's hands); and the like. A return may represent a change to the contract of sale (e.g., the order), and where the e-commerce platform 100 may make the merchant aware of compliance issues with respect to legal obligations (e.g., with respect to taxes). In some embodiments, the e-commerce platform 100 may enable merchants to keep track of changes to the contract of sales over time, such as implemented through a sales model component (e.g., an append-only date-based ledger that records sale-related events that happened to an item).

### Implementations

The methods and systems described herein may be deployed in part or in whole through a machine that executes computer software, program codes, and/or instructions on a processor. The processor may be part of a server, cloud server, client, network infrastructure, mobile computing platform, stationary computing platform, or other computing platform. A processor may be any kind of computational or processing device capable of executing program instructions, codes, binary instructions and the like. The processor may be or include a signal processor, digital processor, embedded processor, microprocessor or any variant such as a co-processor (math co-processor, graphic co-processor, communication co-processor and the like) and the like that may directly or indirectly facilitate execution of program code or program instructions stored thereon. In addition, the processor may enable execution of multiple programs, threads, and codes. The threads may be executed simultaneously to enhance the performance of the processor and to facilitate simultaneous operations of the application. By way of implementation, methods, program codes, program instructions and the like described herein may be implemented in one or more threads. The thread may spawn other threads that may have assigned priorities associated with them; the processor may execute these threads based on priority or any other order based on instructions provided in the program code. The processor may include memory that stores methods, codes, instructions and programs as described herein and elsewhere. The processor may access a storage medium through an interface that may store methods, codes, and instructions as described herein and elsewhere. The storage medium associated with the processor for storing methods, programs, codes, program instructions or other type of instructions capable of being executed by the computing or processing device may include but may not be limited to one or more of a CD-ROM, DVD, memory, hard disk, flash drive, RAM, ROM, cache and the like.

A processor may include one or more cores that may enhance speed and performance of a multiprocessor. In some embodiments, the process may be a dual core processor, quad core processors, other chip-level multiprocessor and the like that combine two or more independent cores (called a die).

The methods and systems described herein may be deployed in part or in whole through a machine that executes computer software on a server, cloud server, client, firewall, gateway, hub, router, or other such computer and/or networking hardware. The software program may be associated with a server that may include a file server, print server, domain server, internet server, intranet server and other variants such as secondary server, host server, distributed server and the like. The server may include one or more of memories, processors, computer readable media, storage media, ports (physical and virtual), communication devices, and interfaces capable of accessing other servers, clients, machines, and devices through a wired or a wireless medium, and the like. The methods, programs or codes as described herein and elsewhere may be executed by the server. In addition, other devices required for execution of methods as described in this application may be considered as a part of the infrastructure associated with the server.

The server may provide an interface to other devices including, without limitation, clients, other servers, printers, database servers, print servers, file servers, communication servers, distributed servers and the like. Additionally, this coupling and/or connection may facilitate remote execution of programs across the network. The networking of some or all of these devices may facilitate parallel processing of a program or method at one or more locations without deviating from the scope of the disclosure. In addition, any of the devices attached to the server through an interface may include at least one storage medium capable of storing methods, programs, code and/or instructions. A central repository may provide program instructions to be executed on different devices. In this implementation, the remote repository may act as a storage medium for program code, instructions, and programs.

The software program may be associated with a client that may include a file client, print client, domain client, internet client, intranet client and other variants such as secondary client, host client, distributed client and the like. The client may include one or more of memories, processors, computer readable media, storage media, ports (physical and virtual), communication devices, and interfaces capable of accessing other clients, servers, machines, and devices through a wired or a wireless medium, and the like. The methods, programs or codes as described herein and elsewhere may be executed by the client. In addition, other devices required for execution of methods as described in this application may be considered as a part of the infrastructure associated with the client.

The client may provide an interface to other devices including, without limitation, servers, other clients, printers, database servers, print servers, file servers, communication servers, distributed servers and the like. Additionally, this coupling and/or connection may facilitate remote execution of programs across the network. The networking of some or all of these devices may facilitate parallel processing of a program or method at one or more locations without deviating from the scope of the disclosure. In addition, any of the devices attached to the client through an interface may include at least one storage medium capable of storing methods, programs, applications, code and/or instructions. A central repository may provide program instructions to be executed on different devices. In this implementation, the remote repository may act as a storage medium for program code, instructions, and programs.

The methods and systems described herein may be deployed in part or in whole through network infrastructures. The network infrastructure may include elements such as computing devices, servers, routers, hubs, firewalls, clients, personal computers, communication devices, routing devices and other active and passive devices, modules and/or components as known in the art. The computing and/or non-computing device(s) associated with the network infrastructure may include, apart from other components, a storage medium such as flash memory, buffer, stack, RAM, ROM and the like. The processes, methods, program codes, instructions described herein and elsewhere may be executed by one or more of the network infrastructural elements.

The methods, program codes, and instructions described herein and elsewhere may be implemented in different devices which may operate in wired or wireless networks. Examples of wireless networks include 4th Generation (4G) networks (e.g., Long-Term Evolution (LTE)) or 5th Generation (5G) networks, as well as non-cellular networks such as Wireless Local Area Networks (WLANs). However, the principles described therein may equally apply to other types of networks.

The operations, methods, programs codes, and instructions described herein and elsewhere may be implemented on or through mobile devices. The mobile devices may include navigation devices, cell phones, mobile phones, mobile personal digital assistants, laptops, palmtops, netbooks, pagers, electronic books readers, music players and the like. These devices may include, apart from other components, a storage medium such as a flash memory, buffer, RAM, ROM and one or more computing devices. The computing devices associated with mobile devices may be enabled to execute program codes, methods, and instructions stored thereon. Alternatively, the mobile devices may be configured to execute instructions in collaboration with other devices. The mobile devices may communicate with base stations interfaced with servers and configured to execute program codes. The mobile devices may communicate on a peer-to-peer network, mesh network, or other communications network. The program code may be stored on the storage medium associated with the server and executed by a computing device embedded within the server. The base station may include a computing device and a storage medium. The storage device may store program codes and instructions executed by the computing devices associated with the base station.

The computer software, program codes, and/or instructions may be stored and/or accessed on machine readable media that may include: computer components, devices, and recording media that retain digital data used for computing for some interval of time; semiconductor storage known as random access memory (RAM); mass storage typically for more permanent storage, such as optical discs, forms of magnetic storage like hard disks, tapes, drums, cards and other types; processor registers, cache memory, volatile memory, non-volatile memory; optical storage such as CD, DVD; removable media such as flash memory (e.g., USB sticks or keys), floppy disks, magnetic tape, paper tape, punch cards, standalone RAM disks, Zip drives, removable mass storage, off-line, and the like; other computer memory such as dynamic memory, static memory, read/write storage, mutable storage, read only, random access, sequential access, location addressable, file addressable, content addressable, network attached storage, storage area network, bar codes, magnetic ink, and the like.

The methods and systems described herein may transform physical and/or or intangible items from one state to another. The methods and systems described herein may also transform data representing physical and/or intangible items from one state to another, such as from usage data to a normalized usage dataset.

The elements described and depicted herein, including in flow charts and block diagrams throughout the figures, imply logical boundaries between the elements. However, according to software or hardware engineering practices, the depicted elements and the functions thereof may be implemented on machines through computer executable media having a processor capable of executing program instructions stored thereon as a monolithic software structure, as standalone software modules, or as modules that employ external routines, code, services, and so forth, or any combination of these, and all such implementations may be within the scope of the present disclosure. Examples of such machines may include, but may not be limited to, personal digital assistants, laptops, personal computers, mobile phones, other handheld computing devices, medical equipment, wired or wireless communication devices, transducers, chips, calculators, satellites, tablet PCs, electronic books, gadgets, electronic devices, devices having artificial intelligence, computing devices, networking equipment, servers, routers and the like. Furthermore, the elements depicted in the flow chart and block diagrams or any other logical component may be implemented on a machine capable of executing program instructions. Thus, while the foregoing drawings and descriptions set forth functional aspects of the disclosed systems, no particular arrangement of software for implementing these functional aspects should be inferred from these descriptions unless explicitly stated or otherwise clear from the context. Similarly, it will be appreciated that the various steps identified and described above may be varied, and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

The methods and/or processes described above, and steps thereof, may be realized in hardware, software or any combination of hardware and software suitable for a particular application. The hardware may include a general-purpose computer and/or dedicated computing device or specific computing device or particular aspect or component of a specific computing device. The processes may be realized in one or more microprocessors, microcontrollers, embedded microcontrollers, programmable digital signal processors or other programmable devices, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine-readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software, or any other machine capable of executing program instructions.

Thus, in one aspect, each method described above, and combinations thereof may be embodied in computer executable code that, when executing on one or more computing devices, performs the steps thereof. In another aspect, the methods may be embodied in systems that perform the steps thereof and may be distributed across devices in a number of ways, or all of the functionality may be integrated into a dedicated, standalone device or other hardware. In another aspect, the means for performing the steps associated with the processes described above may include any of the hardware and/or software described above. All such permutations and combinations are intended to fall within the scope of the present disclosure.

1. A computer-implemented method comprising:
receiving an indication of a set of users, the set of users identified based on user data;
identifying at least one token attribute correlated to the set of users;
identifying a plurality of blockchain wallet addresses associated with wallets each holding one or more tokens matching the token attribute; and
generating and sending a communication to addresses linked to the wallet addresses associated with the wallets holding the matching tokens.

2. The method of claim 1, wherein receiving the indication of the set of users includes identifying, in a database of user data relating to an online platform, the set of users based on a user characteristic.

3. The method of claim 2, wherein the user characteristic is based on user history on the online platform.

4. The method of claim 1, wherein receiving includes receiving blockchain wallet addresses for at least some users in the set of users, and wherein identifying the at least one token attribute includes comparing wallet holdings or wallet history for the blockchain wallet addresses to identify the at least one token attribute.

5. The method of claim 4, wherein comparing wallet holding or wallet history includes:
obtaining wallet data for the blockchain wallet addresses from a blockchain node; and
identifying the at least one token attribute through finding a common feature of the blockchain wallet addresses in the wallet data.

6. The method of claim 4, wherein identifying the at least one token attribute includes determining that more than a threshold percentage of the blockchain wallet addresses has the at least one token attribute.

7. The method of claim 1, wherein identifying the at least one token attribute includes comparing wallet data associated with users in the set of users with wallet data associated with users not in the set of users and determining that the at least one token attribute is correlated with membership in the set of users.

8. The method of claim 1, wherein the at least one token attribute includes holding a non-fungible token from a specific token collection.

9. The method of claim 1, wherein identifying the plurality of blockchain wallet addresses includes searching blockchain data regarding a blockchain based on the at least one token attribute to find the plurality of blockchain wallet addresses having the at least one token attribute.

10. The method of claim 9, wherein searching includes filtering the blockchain data to exclude at least some wallet addresses.

11. The method of claim 10, wherein filtering includes filtering to exclude wallet addresses associated with the set of users.

12. The method of claim 10, wherein filtering includes filtering to exclude a wallet address based on a measure of transfer activity in the wallet address.

13. A computing system, comprising:
one or more processing units;
one or more data storage units; and
memory storing processor-executable instructions that, when executed by the one or more processing units, are to cause the processing units to:
receive an indication of a set of users, the set of users identified based on user data;
identify at least one token attribute correlated to the set of users;
identify a plurality of blockchain wallet addresses associated with wallets each holding one or more tokens matching the token attribute; and
generate and send a communication to addresses linked to the wallet addresses associated with the wallets holding the matching tokens.

14. The computing system of claim 13, wherein the instructions, when executed, are to cause the one or more processing units to receive the indication of the set of users by identifying, in a database of user data relating to an online platform, the set of users based on a similarity measurement.

15. The computing system of claim 14, wherein the user characteristic is based on user history on the online platform.

16. The computing system of claim 13, wherein the memory stores blockchain wallet addresses for at least some users in the set of users and wherein the instructions, when executed, are to cause the one or more processing units to identify the at least one token attribute by comparing wallet holdings or wallet history for the blockchain wallet addresses to identify the at least one token attribute.

17. The computing system of claim 16, wherein comparing wallet holding or wallet history includes:
obtaining wallet data for the blockchain wallet addresses from a blockchain node; and
identifying the at least one token attribute through finding a common feature of the blockchain wallet addresses in the wallet data.

18. The computing system of claim 16, wherein the instructions, when executed, are to cause the one or more processing units to identify the at least one token attribute by determining that more than a threshold percentage of the blockchain wallet addresses has the at least one token attribute.

19. The computing system of claim 13, wherein the instructions, when executed, are to cause the one or more processing units to identify the at least one token attribute by comparing wallet data associated with users in the set of users with wallet data associated with users not in the set of users and determining that the at least one token attribute is correlated with membership in the set of users.

20. The computing system of claim 13, wherein the at least one token attribute includes holding a non-fungible token from a specific token collection.

21. The computing system of claim 13, wherein the instructions, when executed, are to cause the one or more processing units to identify the plurality of blockchain wallet addresses by searching blockchain data regarding a blockchain based on the at least one token attribute to find the plurality of blockchain wallet addresses having the at least one token attribute.

22. The computing system of claim 21, wherein searching includes filtering the blockchain data to exclude at least some wallet addresses.

23. The computing system of claim 22, wherein filtering includes filtering to exclude a wallet address based on a measure of transfer activity in the wallet address.

24. A non-transitory computer-readable media storing processor-executable instructions, wherein the instructions, when executed, are to cause one or more processing units to:
receive an indication of a set of users, the set of users identified based on user data;
identify at least one token attribute correlated to the set of users;
identify a plurality of blockchain wallet addresses associated with wallets each holding one or more tokens matching the token attribute; and
generate and send a communication to addresses linked to the wallet addresses associated with the wallets holding the matching tokens.
